(19) United States
(12) Patent Application Publication
(10) Pub. No.: US 2004/0239894 A1
(43) Pub. Date: Dec. 2, 2004

(54) Light souce apparatus and image display apparatus

(76) Inventor: Yutaka Shimada, Tokyo (JP)

Correspondence Address: JAY H. MAIOLI, Cooper & Dunham LLP, 1185 Avenue of the Americas, New York, NY, 10036, US

(21) Appl. No.: 10/825,004

(22) Filed: Apr. 15, 2004

(30) Foreign Application Priority Data
Apr. 16, 2003 (JP) P2003-111609

(51) Int. Cl. G03B 21/28

(52) U.S. Cl. 353/98

(57) ABSTRACT

In a light source apparatus unit, the light source produces white light that is obtained through a light emission caused by ionization of a gas, with laser light being emitted from a semiconductor laser. The light source of such white light can be treated practically as a point light source. In addition, the white light has a uniform band level in a visible light band. Further, an image display apparatus is composed such that monochromatic light for a color image is taken out from such white light to be displayed. With respect to an image displayed by the image display apparatus, a pixel can be made small to the extent to approximate the light source. Furthermore, the monochromatic light displayed is almost uniform in a balance of light emitting intensity without dispersion.

### BACKGROUND OF THE INVENTION

1. Field of the Invention

The present invention relates to a light source apparatus and an image display apparatus including the light source apparatus.

2. Description of the Related Art

There have been known various kinds of image display apparatuses having a unit as a light source (lamp) and displaying an image using light projected from this light source.

Meanwhile, the light source adapting a principle of an incandescent lamp or a fluorescent lamp is well known as a kind of such light source having an electrode. In an incandescent lamp, the electrode emits light when an electric current is applied to the electrode such as a filament. Also, the fluorescent lamp performs electric discharge between the electrodes and emits visible light by irradiating an ultraviolet ray acquired from this electric discharge on a fluorescent substance.

In addition, a so-called electrodeless discharge lamp is known as a light source having no electrode. Such electrodeless discharge lamp is structured such that an electromagnetic wave is generated by an electric current of high frequency through an application of a principle of electromagnetic induction and the fluorescent substance inside a glass tube is made to emit light by this electromagnetic wave.

Further, there is also known a structure of a lamp, in which laser light is irradiated on an incandescent emitter or an electron emitter to be heated and this incandescent emitter or electron emitter is made to emit the light (refer to Patent reference 1).

[Patent Reference 1]

Japanese Laid-open Patent Application No. H06-243845

For example, when the light source is used in a color image display apparatus, it is desirable that a band of visible light is made as uniform as possible, by reasons that an intensity balance among monochromatic rays required for a color image can be easily obtained and also a design can be simplified.

Further, as an image display apparatus, there is a case in which the light source is required to be a point light source as small as possible.

Furthermore, as a basic feature, it is desirable that the light source has as a longer operation life as possible.

However, first, in case of the incandescent lamp for example, it is necessary to raise a temperature of the electrode in order to make the band of visible light uniform; however, in order to raise the temperature, an amount of applying electric current must increase and therefore, power efficiency may become deteriorated. Moreover, since the electrode as a light emitting source has a limited size but the size of the electrode of the incandescent lamp is comparably large, the size of the electrode is the minimum and is not used as the point light source, even though the light is condensed.

Further, theoretically it is much difficult for the incandescent lamp to attain a longer operating life, because the electrode is worn and damaged to emit no light at a comparatively early stage.

Moreover, in case of the fluorescent lamp, it has a band characteristic of visible light which is not excellent at the uniformity due to the fluorescent light based on mercury emission line. In addition, also in this case, a whole fluorescent tube as the fluorescent lamp is a light emitting source, which is not a point light source.

Furthermore, since a high-speed pulse drive is theoretically difficult, response sensitivity is very low considering a control over emission/non-emission of light in an image display level, for example. The same description can also be applied to the above described incandescent lamp. For example, it is also difficult for the fluorescent lamp to attain a longer operating life, and degradation thereof will occur more rapidly when performing the emission/non-emission of light at a higher speed, for example.

On the other hand, the light source of electrodeless discharge using the electromagnetic induction is superior to the light source having the electrode such as the above described incandescent lamp or fluorescent lamp in terms of a considerably longer life expected.

However, due to the structure of emitting light from a whole discharge tube, it is difficult to make the light source of electrodeless discharge be the point light source. Further, with the structure of generating the electromagnetic wave by applying an electric current of high frequency, it is necessary to control a leak electric field intensity caused by a high frequency, and also since the structure is complicated, it is difficult to make the light source apparatus small-sized.

It should be noted that a structure of making the fluorescent substance emit light by colliding electron beams from an electron gun with the fluorescent substance is also known in a cathode-ray tube corresponding to the light source of the display apparatus. However, the reduction in size is extremely difficult when the whole cathode-ray tube is considered to be one light source, for example. Further, in order to display a color image, a structure in which electron beams collide with fluorescent substances of R, G, and B is adopted as widely known. In this case, it is known that light emission efficiency is not equal among respective fluorescent substances of R, G, and B. In other words, in light of color image display, a problem similar to the fact that a band of visible light of the light source is not uniform has arisen as the difference of light emission efficiency among respective fluorescent substances of R, G, and B.

### SUMMARY OF THE INVENTION

Accordingly, in light of the above mentioned problem, the present invention aims to provide a light source apparatus satisfying respective conditions of: having a uniform band of visible light, existing as the point light source, and having a longer operating life; and also to provide an image display apparatus using such light source apparatus.

For this purpose, first, the following structure is provided for the light source apparatus.

Specifically, the light source apparatus includes: a semiconductor laser; a laser driving means for making the semiconductor laser emit laser light; and a light emitting unit in which a gas is sealed to ionize and emit light by an irradiation of laser light having a required energy or more and which is formed to irradiate the light, obtained by irradiating the laser light with the required energy or more emitted from the semiconductor laser to the gas, to the outside as the light source.

According to the above described structure, the light source apparatus of the present invention employs the semiconductor laser which has lately a longer operating life as a light emitting source. Further, the laser light emitted from the semiconductor laser is made to irradiate onto gas by giving an energy required for ionizing, thereby obtaining the light as the light source. In this case, a size of the light emitting source depends on a wavelength emitted from the semiconductor laser. Furthermore, the light obtained from such light emitting phenomenon is the light which is not accompanied by the luminescence of the fluorescent substance or the like.

Further, a following structure is provided for the image display apparatus.

The image display apparatus of the present invention includes a light source unit and an image display unit which displays an image by incident light emitted from the light source unit as the light source.

Further, the light source unit is composed of a semiconductor laser; a laser driving means for making the semiconductor laser emit laser light; and a light emitting unit on which the laser light emitted from the semiconductor laser is incident and in which a gas that excites emission of white light in accordance with the irradiation of the laser light having a required energy or more is sealed to irradiate the white light as the light source to the outside.

Further, the image display unit includes a monochromatic light generating means for generating monochromatic light of a required color from the incident white light as the light source and an image light generating means for generating visually recognizable image light from the monochromatic light generated by the monochromatic light generating means.

The image display apparatus according to the present invention including the equivalent structure to the above described light source apparatus has the structure in which monochromatic light is taken out of the light entered from the light source unit as the light source and an image light obtained from the monochromatic light is displayed.

Herein, light as the light source, which is emitted from the light source unit of the present invention, is not accompanied by the luminescence of the fluorescent substance or the like as described above, and therefore is not affected by non-uniformity of a band of visible light, which originates in the fluorescent substance. In the case where monochromatic light is taken out of such light, the light emission efficiency is unaffected by the non-uniformity of a visible light band, which is originated in the fluorescent substance no matter what color of a monochromatic light is taken out, as long as it is, for example, within the range of the visible light band.

Furthermore, the fact that light as the light source has the size of the light emitting source depending on the wavelength emitted from the semiconductor laser indicates that it is possible to restore almost to the size as this light emitting source, when it becomes ultimately the image display light.

### BRIEF DESCRIPTION OF THE DRAWINGS

FIG. 1 is a diagram showing an overall configuration of an embodiment of an image display apparatus according to the present invention;

FIG. 2 is a perspective view showing a structural example of a light source apparatus unit in the image display apparatus of the embodiment;

FIG. 3 is a perspective view showing a structural example of a monochromator/scanner unit in the image display apparatus of the embodiment; and

FIGS. 4A to 4C are diagrams showing modified examples of the light source apparatus unit.

### DESCRIPTION OF THE PREFERRED EMBODIMENTS

Hereinafter, an embodiment of the present invention is explained. As the embodiment, an image display apparatus capable of displaying a color image is presented as an example.

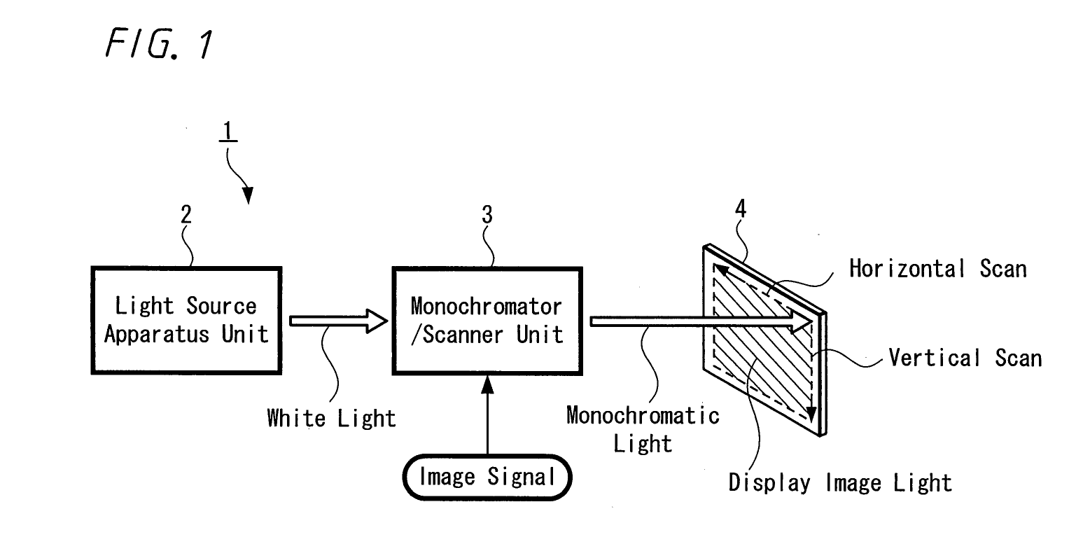

FIG. 1 conceptually shows a configuration of an image display apparatus 1 according to the embodiment. As shown in the diagram, the image display apparatus 1 of the embodiment is mainly composed of a light source apparatus unit 2, a monochromator/scanner unit 3, and a transmissive screen 4.

The light source apparatus unit 2 is an apparatus unit which emits and projects white light as a light source. The white light projected from this light source apparatus unit 2 enters the monochromator/scanner unit 3.

In the monochromator/scanner unit 3, a component of required monochromatic light is taken out of the entered white light to irradiate on a rear surface side of the transmissive screen 4.

In addition, the monochromator/scanner unit 3 controls a course of the monochromatic light so that the monochromatic light can be scanned in horizontal and vertical directions on the transmissive screen 4, while the monochromatic light irradiated on the rear surface side of the transmissive screen 4 becomes a spot having a predetermined size. Accordingly, display image light as a raster image of the monochromatic light is projected on the transmissive screen 4. A viewer watches, from a front surface of the transmission type screen 4, the display image light thus projected on the transmissive screen 4 as an image.

Hereupon, an operation of taking out the monochromatic light component in the monochromator/scanner unit 3 is performed according to color data contained in an inputted image signal. Further, the horizontal scan and the vertical scan are also performed based on a horizontal synchronization signal and a vertical scanning signal which are reproduced from the same image signal.

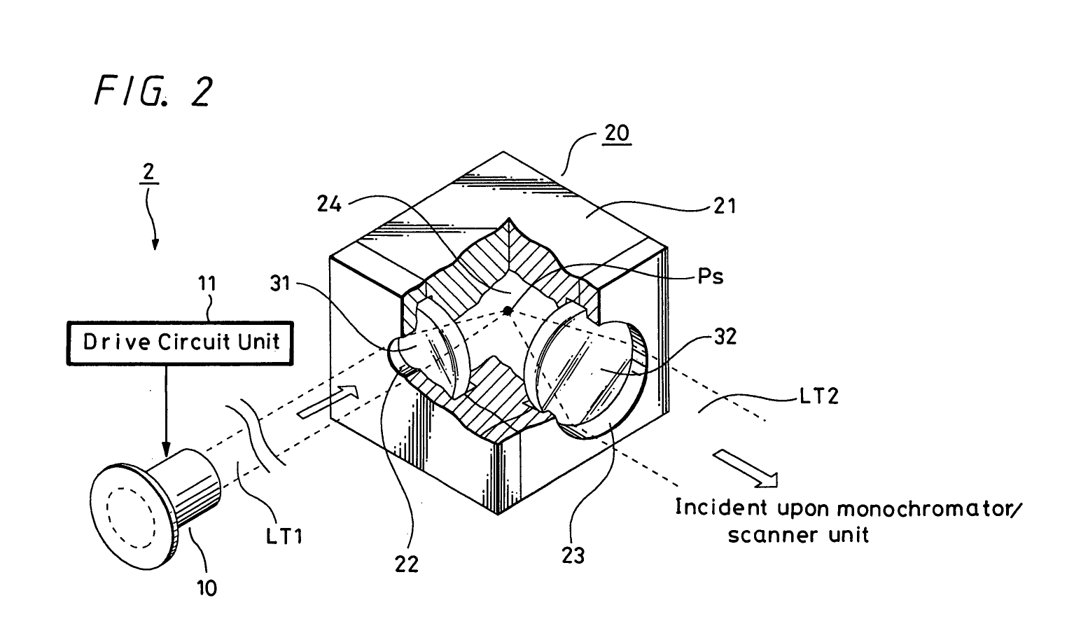

FIG. 2 shows a structural example of the light source apparatus unit 2. This light source apparatus unit 2 is mainly composed of a semiconductor laser 10, a drive circuit 11, and a light emitting unit 20.

The semiconductor laser 10 is to emit and output laser light LT1 of, for example, a predetermined wavelength and the semiconductor laser 10 is driven by the drive circuit 11 to emit light. In this case, a pulse drive by a predetermined pulse cycle is performed and therefore with respect to the laser light LT1, pulse light emission corresponding to the above described pulse cycle is also performed.

A cavity 21 of the light emitting unit 20 has a box shape of a hexahedron in this case.

In addition, an objective lens 31 is attached to one side surface of the cavity 21. The objective lens 31 exposes an approximately central part thereof to the outside through a light pass hole portion 22 which is formed in the cavity 21. In other words, light can be transmitted through the objective lens 31 between the inside and outside of the cavity 21 at a position of the light pass hole portion 22.

Further, a collimate lens 32 is attached to one side surface next to the above side surface where the objective lens 31 is attached such that an approximately central part thereof is exposed to the outside by a light pass hole portion 23. Therefore, light can also be transmitted through the collimate lens 32 between the inside and outside of the cavity 21.

In a state where the objective lens 31 and the collimate lens 32 are attached in this manner, a predetermined kind of gas 24 is sealed in a space inside the cavity 21 such that, for example, a predetermined atmospheric pressure can be maintained.

The laser light LT1 is projected from the semiconductor laser 10 to enter the objective lens 31 through the light pass hole portion 22, and then is condensed with respect to the space of the cavity 21 to be projected. In addition, the laser light LT1 passing through the objective lens 31 is made to focalize at a position, for example, shown as a light emitting point Ps in the cavity 21.

Energy density of the laser light LT1 becomes higher in accordance with convergence of the laser light LT1, so that the energy at the condensed position also becomes higher. Further in this case, the energy of the laser light LT1 which is sufficient to ionize the gas 24 is obtained in a state of being condensed at the light emitting point Ps. Accordingly, the gas 24 ionizes at the light emitting point Ps. At this time, since the laser light LT1 is emitted by a pulse drive, a relaxation of ionization arises in the gas 24; however, a phenomenon of emitting light can be obtained in the process of relaxation of ionization.

In this case, light obtained by the light emitting phenomenon due to the ionization of the gas 24 as described above is so-called white light. The white light is the light in which color components are distributed in a visible light band as the band of the light. Then, in this case the white light thus obtained is collimated and projected to the outside through the collimate lens 32 as shown in the figure. White light LT2 projected through this collimate lens 32 enters the monochromator/scanner unit 3. In other words, this white light LT2 is used as the light source for displaying an image in the image display apparatus 1 of the embodiment.

Hereupon, in the light source apparatus unit 2 of the embodiment having the structure as heretofore explained, the white light generated as described above in the light emitting unit 20 is the light in which a spectrum is distributed in an approximately uniform level with respect to the visible light band between an infrared ray and an ultraviolet ray. In other words, it is not such white light that a band level of one color component greatly differs from another band level of a certain color component in a band of visible light.

On the other hand, when an ultraviolet ray generated, for example, by an electric discharge is irradiated on a fluorescent substance so as to obtain white light by making the fluorescent substance emit light or an electrode such as a filament is made to emit light as represented by an incandescent lamp or the like, there arises dispersion with respect to the distribution of visible light band inherent in those fluorescent substance and electrode. In other words, the uniform distribution in the visible light band as the above embodiment can not be obtained.

Also, although the white light emitted as described above has a light emitting source of the light emitting point Ps, the light emitting point Ps in this case is specifically the focal position of the laser light LT1.

Therefore, one of the elements which determine the spot size of the laser light LT1 at this light emitting point Ps is a wavelength of the laser light LT1. Also, another element is NA of the objective lens 31.

Accordingly, in the case where the focal position is made to be the light emitting source in the embodiment of the present invention, a size of the light emitting source can be set by the selection of the wavelength of the laser light LT1 and the NA of the objective lens 31. In addition, in case that this focal point is the light emitting source, the minimum size of the light emitting source can be set.

The size of the light emitting source set in this manner can be easily made in a range approximately from several micrometers to less than one micrometer at present. Then, if the size of the light emitting source is around this range, it can be practically handled as a so-called point light source.

Further, the size of the light emitting source is not necessarily made into the minimum size which corresponds to the focal point as long as sufficient energy of the laser light for ionizing the gas 24 can be obtained. Specifically, according to the embodiment of the present invention, while a case where the light emitting source is made to be the focal point is the minimum size of the light emitting source, it is also possible to set the size of the light emitting source larger than this, as need arises.

Furthermore, according to the above described light emitting principle, a component of an ultraviolet ray is excluded from the white light generated in the light emitting unit 20. In other words, safety will also be secured without any component of a detrimental light beam. Moreover, a fluorescent substance or the like is not required and therefore, since a noxious material such as mercury for example is also not used, the safety is reliably secured from this view point and it is friendly to the global environment.

Further, according to the structure of the light source apparatus unit 2, a simple configuration is employed with respect to the light emitting unit 20 in which the semiconductor laser 10, the drive circuit 11 for driving thereof, the objective lens 31, the collimate lens 32 and the like are attached and the gas 24 is sealed to form the cavity 21. In other words, since the structure is simplified and therefore, a design and manufacturing can also be performed easily and flexibly, a reduction in cost can also be attained.

In addition, it can be understood from the explanation heretofore provided that main functions of the cavity 21 are making the laser light be capable of irradiating on the gas 24 and irradiating the light generated by the ionization of the gas 24 to the outside, while maintaining the state in which the gas 24 is sealed.

Therefore, as long as a portion to transmit the light is formed in the cavity 21 so that the light condensed by, for example, the objective lens can be irradiated on the gas 24, the objective lens 31 may be provided in a state of not being incorporated into the cavity 21. The same description can also be applied to the collimate lens 32 in this respect. However, if the objective lens 31 and the collimate lens 32 are integrally formed to be incorporated into the cavity 21 as is the case of the embodiment, the number of parts forming the light source apparatus unit 2 is reduced as a result, and it is possible to make the structure simplified and small-sized.

Also, since only the semiconductor laser 10 will deteriorate in performance by aging with respect to parts consisting of the light source unit 2, an operating life of the light source apparatus unit 2 may depend upon an operating life of the semiconductor laser 10; however, the semiconductor laser 10 in recent years has a longer operating life, for example, from several hundreds thousands of hours to several millions of hours, which is ten to one hundred times longer in comparison with the fluorescent lamp. Moreover, even if driving such as flashing on and off at a high speed is repeated, the operating life thereof may be prevented from being remarkably short, which is the case of a fluorescent lamp.

Further, since the semiconductor laser 10 performs a high-speed response and copes with a pulse drive such as high-speed flashing, a high flexibility can also be given to a driving method. This leads to the fact that the high-speed response can be obtained when performing a moving image display.

Furthermore, as a semiconductor laser, there is one which can be driven by a low electric current of, for example, around several milliamperes and when such one is selected, power consumption in the light source apparatus unit 2 can be made very small.

Moreover, since heat generated in each of the semiconductor laser 10 and the light emitting unit 20 constituting the light source apparatus unit 2 is not considerable, such advantages as high flexibility when actually mounted in the apparatus and easy handling, for example, can also be obtained.

Note that although the kind of gas 24 sealed in the cavity 21 is not particularly specified, it is necessary to have a property with which ionization is excited when the laser light having energy of a fixed level or more is irradiated.

For example, hydrogen, nitrogen, oxygen, helium, argon, krypton, xenon and the like are named as specific examples; however if nitrogen is adopted in practical use, the cost performance will be improved, because nitrogen is less expensive.

Further, the atmospheric pressure inside the cavity 21 should be set such that the ionization of the gas 24 is assured in consideration of the kind of gas 24 and the energy of the laser light LT1 actually irradiated on the gas 24.

Also, it can be said from the above explanation that the main functions of the cavity 21 are enabling the laser light to irradiate on the gas 24 and enabling the light generated by the ionization of the gas 24 to irradiate to the outside, while maintaining the state in which the gas 24 is sealed. Therefore, the objective lens 31 may be provided in a state of not being incorporated into the cavity 21 as long as a portion which transmits the light is formed in the cavity 21 such that the light condensed by, for example, the objective lens can be irradiated on the gas 24.

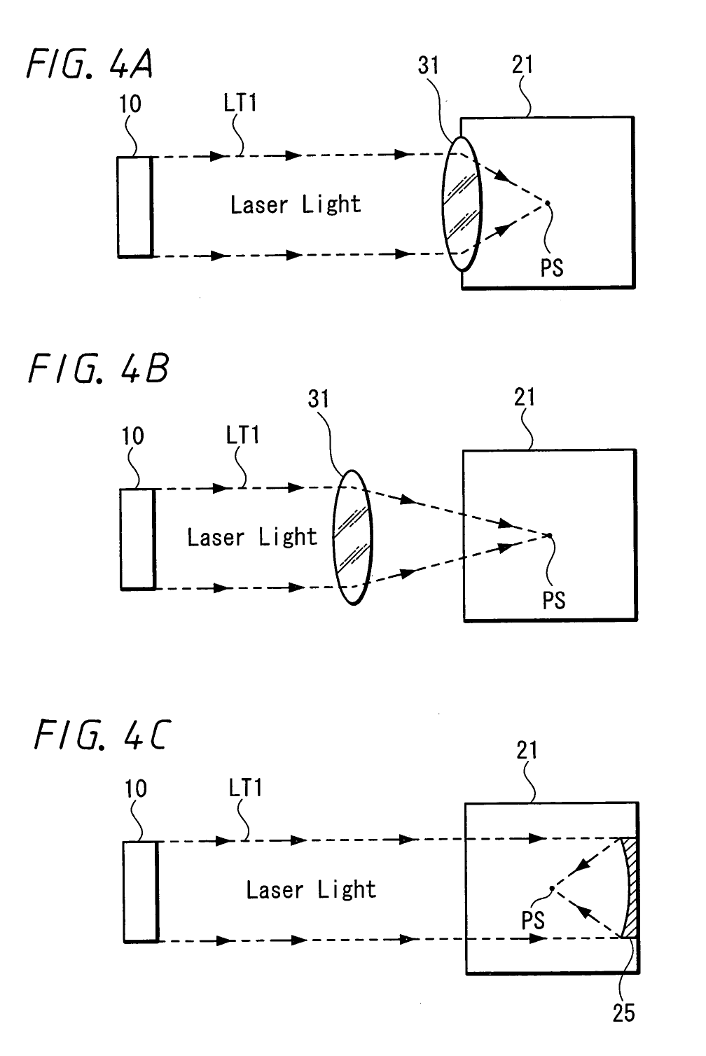

An explanation is further made in this respect by referring to FIGS. 4A and 4B. The cavity 21 shown in FIG. 2 can be shown as FIG. 4A. In FIG. 4A, the laser light LT1 emitted from the semiconductor laser 10 is condensed by the objective lens 31 attached to the cavity 21, so that the light emitting point Ps can be obtained in the cavity 21.

On the other hand, in case of FIG. 4B the objective lens 31 is provided between the semiconductor laser 10 and a laser light LT1 incident surface of the cavity 21. In other words, the cavity 21 and the objective lens 31 are not integrally formed but are provided individually. With this structure, also in this case, the laser light LT1 emitted from the semiconductor laser 10 is condensed by the objective lens 31, so that the light emitting point Ps can be obtained in the cavity 21.

With respect to such modification of the structure, the same explanation can also be applied to the collimate lens 32. However, if the objective lens 31 and the collimate lens 32 are integrally formed to be incorporated into the cavity 21 as is the case of the embodiment of the present invention, the number of parts forming the light source apparatus unit 2 can be reduced as a result and it is possible to make the structure more simplified and small-sized.

Furthermore, an example shown in FIG. 4C can also be employed, given that only a condensed state of the laser light LT1 as the light emitting point Ps needs to be obtained in the cavity 21 as a condition for obtaining the white light.

That is, the objective lens 31 is omitted in this case and instead, a concave mirror 25 is formed on the surface in the cavity 21 where the laser light LT1 is irradiated.

The laser light LT1 projected from the semiconductor laser 10 enters the cavity 21 and reaches the concave mirror 25 to be reflected. The laser light LT1 reflected by the concave mirror 25 is also condensed, so that the light emitting point Ps can be obtained in the cavity 21.

Moreover, since a condition to ionize the gas 24 for the purpose of emitting the white light is that the laser light having energy of fixed level or more is irradiated on the gas 24, a plurality of semiconductor lasers are, for example, used so that required energy can be collected by condensing laser light irradiated from those semiconductor lasers.

That is, a plurality of semiconductor lasers are arranged outside the cavity 21. Then, laser lights irradiated from those semiconductor lasers are made to intersect at one point in the cavity 21. The point where laser lights intersect is the light emitting point Ps and energy of the laser light of a fixed level or more can be obtained, so that a light emitting phenomenon by the ionization can be acquired. In this case, whether the objective lens is provided or not for a light path of each laser light should be appropriately determined in accordance with laser power being set to each semiconductor laser, the required energy of the laser light, and the like.

Furthermore, even the shape of the cavity 21 is not necessarily a cube or rectangular parallelepiped shape as shown in FIG. 2, but it can be almost a sphere.

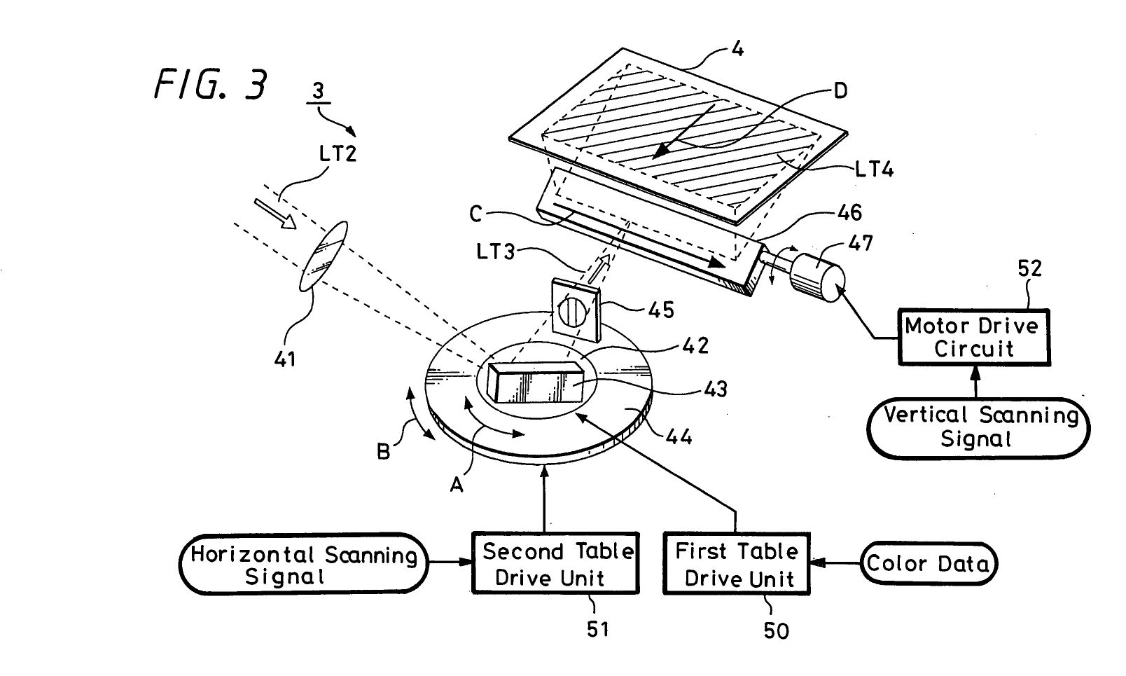

Subsequently, an example of a structure of the monochromator/scanner unit 3 is explained referring to FIG. 3. The monochromator/scanner unit 3 is a unit to perform an image display using the white light LT2 which is projected as a light source from the light source apparatus unit 2 shown in the above described FIG. 2.

First, the white light LT2 projected as the light source from the light source apparatus unit 2 enters an objective lens 41 to be condensed as illustrated. A focal position of this objective lens 41 (focal length) is set so as to be positioned adjacent to a rear surface side of a transmissive screen 4, where light entered the objective lens 41 reaches through a light path explained later on.

The white light LT2 projected from the objective lens 41 enters a diffraction grating 43 which is attached fixedly to a first table portion 42.

The diffraction grating 43 has a wavelength selecting property to select a band of wavelength of reflected light, in which incident light is reflected to be projected, in accordance with an incidence angle of the entering light. That is, different monochromatic light LT3 is selected and projected in accordance with the incidence angle of the entering light.

The first table portion 42 to which this diffraction grating 43 is attached is circular in this case. In addition, the first table portion 42 is driven by a first table drive portion 50 to rotate in clockwise and counterclockwise directions, with an axis of the rotation at the center of the circular shape within a predetermined range as indicated by an arrow A in the diagram.

Corresponding to rotation of the first table portion 42 by the first table drive unit 50 as described above, the incidence angle of the white light LT2 entering the diffraction grating 43 is changed. Accordingly, only a component of the monochromatic light LT3 which is determined according to the incidence angle is selected from the white light LT2 entered the diffraction grating 43 to be reflected and projected.

Hereupon, it is assumed that the range of rotation of the first table portion 42 driven by the above described first table drive unit 50 is set to cover a whole wavelength band of visible light as the wavelength selected by the diffraction grating 43 (color of monochromatic light). With that, it is further assumed that the rotational movement of the first table portion 42 is performed in a continuous form.

In this case, supposing that the rotational movement of the first table 42 is performed, the monochromatic light component which is obtained as the reflection light is changed continuously in the range of visible light.

In other words, according to the embodiment of the present invention, a monochromatic light of the whole wavelength band in the range of visible light can be obtained from the white light LT2.

Further, in the white light LT2 projected from the light source apparatus unit 2 of the embodiment, a spectrum is distributed almost uniformly with respect to a band of visible light as also described in the above. Therefore, monochromatic light obtained from the white light LT2 as described above is also prevented from being dispersed with respect to the intensity depending on the band (wavelength) thereof. In other words, according to the embodiment of the present invention, arbitrary monochromatic light which has no dispersion with respect to the intensity can be obtained as long as a structure to change the incidence angle of the white light LT2 on the diffraction grating 43 is adopted. Specifically, at a stage of the monochromatic light made by the diffraction grating 43, almost fixed intensity balance can be obtained among the arbitrary monochromatic lights.

Further, the first table drive unit 50 in this case drives the first table 42 such that a rotation angle of the first table 42 is set based on, for example, color data corresponding to each pixel inputted to the image display apparatus 1 of the embodiment.

Accordingly, the angle of the white light LT2 incident on the diffraction grating 43, from which monochromatic light indicated by the color data can be obtained as the reflection light, is determined unambiguously by the rotation angle of the first table portion 42. The first table drive unit 50 drives the first table portion 42 to obtain this rotation angle.

If the rotation angle of the first table portion 42 is changed continuously as described above, a color change of the monochromatic light can also be obtained continuously. Accordingly, if only the resolution for controlling the rotation angle in a portion consisting of the first table drive unit 50 and the first table portion 42 is secured, the monochromatic light of an appropriate color corresponding to the resolution of color data can be secured without difficulties.

The monochromatic light LT3 projected as described above from the diffraction grating 43 enters a mirror 46 through a slit 45.

The diffraction grating 43 of the embodiment has, for example, a character due to its structure, in which another different wavelength is selected in addition to an originally required wavelength at a specific angle of the incident light. In order to cope with such a case, the slit 45 is provided for not transmitting the above described another different wavelength so that only the originally required wavelength is made incident on the mirror 46.

The monochromatic light LT3 reflected by the mirror 46 is projected to the rear surface side of the transmissive screen 4. A light spot projected to the rear surface side of the transmissive screen 4 becomes one pixel.

Then, display image light LT4, which is obtained in the above described transmissive screen 4, is to be formed by scanning the above described light spot as the pixel on the transmissive screen 4 in horizontal and vertical directions, for example, at every predetermined field image period.

An operation of displaying the image to form the display image light LT4 in accordance with an input image signal is performed as follows.

First, the color data indicating a color of each pixel is sequentially input to the first table drive unit 50 at a predetermined timing. The first table drive unit 50 drives the first table portion 42 to determine a rotational position thereof so that the angle of the white light LT2 incident on the diffraction grating 43 can be obtained according to the input color data.

Concurrently, a second table drive unit 51 drives a second table portion 44 to rotate in accordance with a horizontal scanning signal extracted from an input image signal.

The second table portion 44 is attached to be capable of rotating in directions shown by an arrow B within a predetermined range, with the first table portion 42 attached to be capable of rotating, for example. With a rotation and movement of this second table portion 44, a spot of the monochromatic light LT3 projected as the reflection light from the diffraction grating 43 is made to move along an arrow C on the mirror 46.

Such movement of the spot of the monochromatic light LT3 on the mirror 46 is obtained as a movement of the light spot in the horizontal direction on the transmissive screen 4. That is, the horizontal scanning is performed to form the display image light LT4.

Also, the vertical scanning is performed as follows.

A vertical scanning signal extracted from the image signal is input into a motor drive circuit 52.

The motor drive circuit 52 controls driving of a motor 52 by controlling a rotation angle of a motor 47, and the mirror 46 is attached to a rotation axis of the motor 47 as illustrated.

Therefore, an angled position of a reflective surface of the mirror 46 is changed according to the rotation of the motor 47, and the spot of the monochromatic light LT3 irradiated on the transmissive screen 4 is made to move along a direction of an arrow D in this case. That is, the vertical scanning is performed so as to form the display image light LT4.

Consequently, the display image light LT4 as the raster image in color can be obtained on the transmissive screen 4 by performing: the control of the rotational position of the first table portion 42 according to the color data; the control of the rotational position of the second table portion 44 according to the horizontal scanning signal; and the control of the angled position of the mirror 46 according to the vertical scanning signal. Accordingly, a color image display is performed by a field (frame) method.

In various kinds of, for example, conventional display apparatuses, a color of one pixel is expressed by using three primary colors such as R, G, and B as one set. In order to do so, one pixel portion is formed by driving, for example, one set of cells of adjacent three R, G and B.

On the other hand, according to the embodiment of the present invention, since arbitrary monochromatic light LT3 within the range of visible light can be obtained from the diffraction grating 44 as heretofore described, one pixel obtained on the transmissive screen 4 as the light spot represents a pixel itself expressing a color according to, for example, the color data. In other words, according to the embodiment, the arbitrary monochromatic light can be obtained more easily without a complicated design in consideration of a balance of light emitting intensity or the like among the fluorescent substance of R, G, and B.

Furthermore, since the white light LT2 which is a source of the monochromatic light LT3 has a uniform band level in the visible light band, in the embodiment there is no dispersion with respect to the intensity balance of color among the pixels displayed by the monochromatic light as described above. Accordingly, also the design in consideration of imbalance among respective colors is not required.

Moreover, the spot of the monochromatic light LT3 obtained on the transmissive screen 4 is obtained by condensing the white light LT2 with the objective lens 41, and the white light LT2 has the light emitting source at the light emitting point Ps shown in FIG. 2. The size of the light emitting source is determined by the wavelength of the laser light LT1 and the NA of the objective lens 31 as described above.

Herein, in order to minimize the spot size on the transmissive screen 4, it is only necessary to set a distance of the light path such that the focal position of the objective lens 41 can be set at the rear surface of the transmissive screen 4. Then, due to the fact that the white light LT2 incident on the objective lens 41 is obtained from the light emitting point Ps as the light emitting source, the spot size at the focal position of the objective lens 41 is also made to coincide with the size of light emitting source of the white light LT2.

Accordingly, the spot size of the monochromatic light LT3 on the transmissive screen 4 can be made into the minimum size equivalent to the light emitting point Ps. Further, the spot size of the monochromatic light LT3 larger than that can be determined arbitrarily by changing the distance of the light path between the objective lens 41 and the transmissive screen 4.

As mentioned above, the size of the light emitting point Ps is in the range from several micrometers to less than one micrometer, and therefore, the size is even smaller in comparison with the case of a pixel having a size of several tens microns formed in, for example, another display apparatus. In other words, according to the image display apparatus of the embodiment, it is possible to form a display image using a pixel smaller than before, and as a result a display image in higher resolution can easily be obtained.

It should be noted that the structure of the monochromator/scanner unit 3 mentioned above is only an example, and other structures can also be considered with respect to the drive to move the light spot to perform the horizontal/vertical scanning and the control for producing the monochromatic light or the like. For example, it is conceivable to adopt a technology called MEMS (Micro Electro Mechanical System) for those operations. Using MEMS technology, the monochromator/scanner unit 3 can be extremely small-sized than the structure shown in FIG. 3.

Further, application of the light source apparatus unit 2 of the heretofore explained embodiment is not specifically limited to the image display apparatus having the structure explained above, and the light source apparatus unit 2 can be applied to other display apparatuses of various kinds which need light sources, such as a liquid crystal display apparatus, a projector apparatus and the like, for example. Moreover, it can also be considered that the light source apparatus unit 2 is applied as other apparatus than a light source of a display apparatus.

For example, the light source apparatus unit 2 according to the embodiment of the present invention can be applied as a medical instrument. Specifically, an assumption is made to a case where a certain affected part inside a body is such a part that absorbs only a certain specific wavelength (spectrum), when white light is irradiated. In this case, an absorption spectrum of a local part, which is obtained when the white light is condensed and irradiated on a human body, is measured by using the fact that the light source according to the present invention has a uniform band level in the visible light band. Based on the result of the measurement and also a spectrum absorption characteristic which is distinctive to every affected part, it is possible to specify what kind of symptom this affected part is suffered from. Thus, the light source of the present invention is suitable as a light irradiating unit of an apparatus for detecting and inspecting the affected part.

Further, the light source apparatus of the present invention can be used, when considering such an image formation apparatus that uses a chemical reaction obtained by irradiating light on a film, paper, membrane and the like to which a silver halide is coated. In this case, since the spot size obtained by condensing the white light from the light source apparatus according to the present invention is very small, it is possible to form minute images and patterns. Furthermore, since the spectrum distribution of the white light is uniform, arbitrary visible light can also be obtained easily. In other words, it is possible to obtain the image formation apparatus in which a color selection and miniaturization can be easily made, when an image is formed.

As explained hereinabove, the light source apparatus of the present invention projects, as a light source, white light which can be obtained accompanied by the ionization of a gas generated by laser light emitted from a semiconductor laser. In this case, a size of a light emitting point is determined by a wavelength of the laser light and a degree of convergence of the laser light when it is condensed to an energy level sufficient for making the gas ionize. Then, a light emitting point obtained in this manner is extremely small and can be treated practically as a point light source.

Further, the white light obtained in this manner has a uniform band level in the visible light band.

Further, although an operating life of the light source apparatus depends mostly on a life of the semiconductor laser in case of the light source apparatus having such structure, the life of the semiconductor laser is considerably long and therefore, the light source apparatus also has a longer operating life. Particularly, since considerable degradation does not occur even if the semiconductor laser is, for example, driven ON/OFF with a high frequency, the long life can be secured even when such high frequency driving is required.

Furthermore, as the light source apparatus of the present invention, since at least the semiconductor laser and a structure for making the laser light of this semiconductor laser incident on a sealed gas with required energy or more are necessary, the structure of the apparatus can be simplified greatly. Accordingly, a reduction in cost becomes possible and also flexibility in a structure becomes large. Moreover, since the semiconductor laser is driven, lower power consumption can be expected than a case in which another light source is driven.

Further, in the image display apparatus of the present invention which uses, as a light source, white light obtained from such light source apparatus, monochromatic light is taken out of the white light of the light source and an image is displayed using this taken-out monochromatic light.

Accordingly, since the monochromatic light is taken out from the white light having a uniform band level of visible light in the image display apparatus of the present invention, almost uniform light emitting intensity is obtained as the taken-out monochromatic light regardless of the wavelength band. In other words, there is no need to take, for example, the dispersion with respect to characteristics of a fluorescent substance or the like into consideration and an image having a favorable balance of color can be displayed.

Furthermore, in this case, the white light as the light source is a point light source and therefore, a spot size of the monochromatic light taken out from this white light can be made small even to the size of the original point light source if it is made to be condensed or so by a lens or the like, for example. Since the spot size of the monochromatic light corresponds to a size of a pixel which forms a display image, it becomes also possible to easily form an image of very high resolution according to the present invention.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

1. A light source apparatus comprising:
a semiconductor laser,
laser driving means for driving said semiconductor laser to emit laser light, and
a light emitting unit on which the laser light emitted from said semiconductor laser is incident and in which a gas that excites an emission of white light in accordance with an irradiation of the laser light having a predetermined energy is sealed to irradiate said white light as a light source.

2. An image display apparatus comprising;
a light source unit; and
an image display unit where light projected from the light source unit enters as a light source to perform an image display, wherein
said light source unit includes:
a semiconductor laser,
laser driving means for driving said semiconductor laser to emit laser light, and
a light emitting unit on which the laser light emitted from said semiconductor laser is incident and in which a gas that excites an emission of white light in accordance with an irradiation of the laser light having a predetermined energy is sealed to irradiate said white light as a light source; and
said image display unit includes:
monochromatic light generating means for generating monochromatic light of a predetermined color from said incident white light as the light source, and
image light generating means for generating visually recognizable image light from the monochromatic light generated by said monochromatic light generating means.

3. The image display apparatus according to claim 2, wherein
said monochromatic light generating means comprises a diffraction grating which reflects and projects variable monochromatic light in accordance with an incidence angle of light.

4. The image display apparatus according to claim 2, wherein
said image light generating means comprises:
a screen; and
lens means that has a predetermined focal length so that the light irradiated on said screen from said light source unit through said image light generating means has a predetermined spot size and is provided at a required position.

5. The image display apparatus according to claim 4, wherein
said image light generating means further comprises:
horizontal scanning means for performing a horizontal scan with respect to the light irradiated on said screen; and
vertical scanning means for performing a vertical scan with respect to the light irradiated on said screen.
